(19) United States
(12) Patent Application Publication
(10) Pub. No.: US 2025/0076504 A1
(43) Pub. Date: Mar. 6, 2025

(54) LIGHT DETECTION AND RANGING DEVICE

(71) Applicant: LightIC Technologies HK Limited, Hong Kong (CN)

(72) Inventors: Guomin JIANG, Santa Clara, CA (US); Zhi LI, Santa Clara, CA (US); Guan WANG, Santa Clara, CA (US); Tianbo SUN, Santa Clara, CA (US); Jie SUN, Santa Clara, CA (US)

(21) Appl. No.: 18/820,613

(22) Filed: Aug. 30, 2024

(30) Foreign Application Priority Data
Aug. 31, 2023 (CN) 202311119692.7

(51) Int. Cl. G01S 17/34; G01S 7/481; G01S 7/4911; G01S 7/4913; G01S 7/499; G01S 17/58

(52) U.S. Cl. CPC G01S 17/34; G01S 7/4814; G01S 7/4816; G01S 7/4911; G01S 7/4913; G01S 7/499; G01S 17/58

(57) ABSTRACT

A LIDAR device is provided which includes a LiDAR chip including a laser transmission detection channel which transmits a detection beam and a local oscillation beam having a first polarization state, and includes: a light transmitting end emitting the detection beam, a reflection beam is generated after the detection beam is reflected by an obstacle, the reflection beam includes a first reflection sub-beam having a first polarization state and a second reflection sub-beam having a second polarization state; a light receiving end receiving at least one of the first and the second reflection sub-beams; a mixer receiving the local oscillation beam and the reflection beam, and performing a frequency-mixing operation on the local oscillation beam and the reflection beam to output a frequency-mixed beam; a detector receiving the frequency-mixed beam and output a detection electrical signal used to determine a distance and/or a speed of the obstacle.

### CROSS-REFERENCE TO RELATED APPLICATION

This application claims a priority to Chinese Patent Application No. 202311119692.7 filed on Aug. 31, 2023, the disclosures of which are incorporated in their entirety by reference herein.

### TECHNICAL FIELD

The present disclosure relates to the field of Light Detection And Ranging (LiDAR device), and in particular, to a LiDAR device.

### BACKGROUND

A LIDAR device is a radar device that emits a laser beam to detect a position, a speed and other characteristic quantities of a target. A working principle of the LiDAR device is to transmit a detection signal to the target, and then compare a received signal reflected from the target with a transmitted signal. After appropriate processing, relevant information about the target can be obtained, such as distance, direction, height, speed, attitude, and even shape parameters of the target, so as to detect, track and identify targets such as aircraft and missiles. The LiDAR device is now widely deployed in different scenarios including automatic vehicles. The LiDAR device can actively estimate the distance and the speed of environmental features when scanning an environmental scene, and generate a point position cloud indicating a three-dimensional shape of the environmental scene. The LiDAR device is one of core sensors widely used in autonomous driving scenarios, and can be used to collect three-dimensional information of the external environment. According to different detection mechanisms, LiDAR devices can be mainly divided into two types of LiDAR devices: a Time of Flight (ToF) LiDAR device and a Frequency Modulated Continuous Wave (FMCW) LiDAR device.

### SUMMARY

Some embodiments of the present disclosure provide a Light Detection And Ranging (LiDAR) device, which includes:
a LiDAR chip, including at least one laser transmission detection channel configured to transmit a detection beam having a first polarization state and a local oscillation beam having the first polarization state, wherein each of the at least one laser transmission detection channel includes: a light transmitting end configured to emit the detection beam, wherein a reflection beam is generated after the detection beam encounters the obstacle and is reflected by the obstacle, the reflection beam includes a first reflection sub-beam having a first polarization state and a second reflection sub-beam having a second polarization state; a light receiving end configured to receive at least one of the first reflection sub-beam and the second reflection sub-beam; one or more mixers configured to receive the local oscillation beam and the reflection beam, and perform a frequency-mixing operation on the local oscillation beam and the reflection beam to output a frequency-mixed beam; and a detector configured to receive the frequency-mixed beam and output a detection electrical signal, wherein a distance and/or a speed of the obstacle is determined based on the detection electrical signal.

In some embodiments, the LiDAR device further includes: a lens assembly configured to collimate and deflect the detection beam emitted from the light transmitting end, and to focus the reflection beam to enable the reflection beam to be coupled into the laser transmission detection channel; and a beam scanning assembly on a side, close to the obstacle, of the lens assembly and configured to adjust an emission direction of the detection beam emitted from the light transmitting end over time to achieve beam scanning.

In some embodiments, the LiDAR device further includes a circulator between the LiDAR chip and the lens assembly, wherein the circulator includes: a first port configured to receive the detection beam; a second port configured to emit the detection beam toward the lens assembly and receive the reflection beam; and a third port configured to transmit the reflection beam to the laser transmission detection channel, so that the first reflection sub-beam and the second reflection sub-beam are coaxially coupled into the light receiving end.

In some embodiments, the laser transmission detection channel further includes: a polarization rotator configured to receive the local oscillation beam and convert the local oscillation beam into a first local oscillation sub-beam having the first polarization state and a second local oscillation sub-beam having the second polarization state, wherein the one or more mixers are configured to receive the first local oscillation sub-beam and the first reflection sub-beam, and perform a frequency-mixing operation on the first local oscillation sub-beam and the first reflection sub-beam to output a first frequency-mixing sub-beam; and the one or more mixers are configured to receive the second local oscillation sub-beam and the second reflection sub-beam, and perform a frequency-mixing operation on the second local oscillation sub-beam and the second reflection sub-beam to output a second frequency-mixing sub-beam; the detector is configured to receive the first frequency-mixing sub-beam and output a first detection electrical sub-signal, and to receive the second frequency-mixing sub-beam and output a second detection electrical sub-signal, the distance and/or the speed of the obstacle are determined based on the first detection electrical sub-signal and the second detection electrical sub-signal by the LiDAR device.

In some embodiments of the present disclosure, the LiDAR chip further includes: a receiving port configured to receive laser light; and a beam splitter configured to split the laser light into the detection beam and the local oscillation beam, wherein the detection beam and the local oscillation beam are configured to be transmitted to the laser transmission detection channel.

In some embodiments, the LiDAR device further includes a polarization transmission beam splitter between the LiDAR chip and the lens assembly, and the polarization transmission beam splitter is configured to: allow the detection beam to pass through with an original direction of the detection beam unchanged; deflect and translate a first reflection sub-beam in the reflection beam so that the first reflection sub-beam is incident on the light receiving end; and allow a second reflection sub-beam in the reflection beam to pass through with an original direction of the second reflection sub-beam unchanged, so that the second reflection sub-beam is incident on the light transmitting end, and the light transmitting end coaxially transmits the detection beam and receives the second reflection sub-beam.

In some embodiments, the local oscillation beam includes a first local oscillation beam and a second local oscillation beam, the one or more mixers include a first mixer and a second mixer respectively arranged on both sides of the detector, wherein the first mixer is configured to receive the first local oscillation beam and the first reflection sub-beam, and perform a frequency-mixing operation on the first local oscillation beam and the first reflection sub-beam to output a first frequency-mixed beam; the second mixer is configured to receive the second local oscillation beam and the second reflection sub-beam, and perform a frequency-mixing operation on the second local oscillation beam and the second reflection sub-beam to output a second frequency-mixed beam; the detector is configured to receive the first frequency-mixed beam and output a first detection electrical signal, and to receive the second frequency-mixed beam and output a second detection electrical signal, wherein the LiDAR device determines the distance and/or the speed of the obstacle based on the first detection electrical signal and the second detection electrical signal.

In some embodiments, the laser transmission detection channel includes: a polarization splitter and rotator configured to receive the second reflection sub-beam, change a polarization state of the second reflection sub-beam from the second polarization state to the first polarization state, and transmit the second reflection sub-beam with the changed polarization state to the second mixer.

In some embodiments, the polarization transmission beam splitter includes a Faraday rotator, a half-wave plate and a polarization beam deflector sequentially away from the LiDAR chip; the detection beam is converted from polarized light in the first polarization state to polarized light in the second polarization state after passing through the Faraday rotator and the half-wave plate in sequence; the polarized light in the second polarization state passes through the polarization beam deflector with an original direction of the polarized light unchanged, and then passes through the lens assembly and the beam scanning assembly in sequence before reaching the obstacle to generate the reflection beam; the reflection beam returns to the polarization beam deflector along an original optical path of transmitting the detection beam; the second reflection sub-beam with the second polarization state in the reflection beam passes through polarization beam deflector with an original direction of the second reflection sub-beam unchanged, and then passes through the half-wave plate and the Faraday rotator in sequence, and then enters the light transmitting end; the first reflection sub-beam with the first polarization state in the reflection beam passes through the polarization beam deflector and is deflected and translated, and then passes through the half-wave plate and the Faraday rotator in sequence, and then enters the light receiving end.

In some embodiments, the LiDAR chip further includes: a receiving port configured to receive laser light; and a beam splitter configured to split the laser light into the detection beam, the first local oscillation beam and the second local oscillation beam; the detection beam, the first local oscillation beam and the second local oscillation beam are configured to be transmitted to the laser transmission detection channel.

Compared with the related art, the above solutions of the embodiments of the present disclosure have at least the following beneficial effects:

The LiDAR device transmits a detection beam with a first polarization state through a transmission detection channel and receives a reflection beam including a first reflection sub-beam with the first polarization state and a second reflection sub-beam with a second polarization state, making full use of the reflection beam to measure obstacles and improve the detection probability. At the same time, it avoids the situation where the obstacle cannot be detected since TM mode polarization light is weak and TE mode polarization light in the reflection beam reflected the obstacle is strong.

### BRIEF DESCRIPTION OF THE DRAWINGS

The drawings herein are incorporated into the specification and constitute a part of the specification, show embodiments consistent with the present disclosure, and together with the specification, are used to explain the principles of the present disclosure. Obviously, the drawings described below are only some embodiments of the present disclosure, and for those skilled in the art, other drawings can be obtained based on these drawings without creative work. In the drawings:

FIG. 1 is a schematic diagram of a structure of a LiDAR device provided in some embodiments of the present disclosure;

FIG. 2 is a schematic diagram of a partial structure of a LiDAR chip provided in some embodiments of the present disclosure;

FIG. 3 is a schematic diagram of a structure of a LiDAR device provided in some embodiments of the present disclosure;

FIG. 4 is a schematic diagram of a partial structure of a LiDAR chip provided in some embodiments of the present disclosure;

FIG. 5 is a waveform diagram of a transmitted light beam and a received light beam of a FWCW frequency sweeping method provided by the present disclosure.

### DETAILED DESCRIPTION

In order to make objectives, technical solutions and advantages of the present disclosure more apparent, the present disclosure will be further described in detail below in conjunction with the accompanying drawings. Obviously, the described embodiments are only part of the embodiments of the present disclosure, rather than all of the embodiments. Based on the embodiments in the present disclosure, all other embodiments obtained by those skilled in the art without creative work are within the protection scope of the present disclosure.

The terms used in the embodiments of the present disclosure are only for the purpose of describing specific embodiments, and are not intended to limit the present disclosure. The singular forms “a”, “said”, and “the” used in the embodiments of the present disclosure and the appended claims are also intended to include plural forms, unless the context clearly indicates other meanings, and “multiple” generally includes at least two.

It should be understood that the term “and/or” used herein is only a description of the association relationship of associated objects, indicating that there can be three relationships. For example, A and/or B can represent: A exists alone, A and B exist at the same time, and B exists alone. In addition, the character “/” herein generally indicates that the associated objects before and after the character are in an “or” relationship.

It should be understood that although the terms “first”, “second”, “third”, etc. may be used in the disclosed embodiments. These terms are only used to distinguish the described objects. For example, without departing from the scope of the disclosed embodiments, the first may also be referred to as the second, and similarly, the second may also be referred to as the first.

It should also be noted that the terms “include”, “comprise” or any other variations thereof are intended to cover non-exclusive inclusion, so that a product or device including a series of elements includes not only those elements, but also other elements not explicitly listed, or also includes elements inherent to such product or device. In the absence of more restrictions, the elements after the expression “comprise a” do not exclude the presence of other identical elements in the product or device including the elements.

In the field of LiDAR, LIDAR devices mainly include the following two technical routes based on the ranging method: ToF (Time of Flight) and FMCW (Frequency-Modulated Continuous Wave). The ranging principle of ToF is to calculate the distance by multiplying the flight time of the light pulse between the target and the ToF device by the speed of light. A ToF device uses pulse amplitude modulation technology. Different from a ToF route, a FMCW device mainly sends and receives continuous laser beams, enables the return light to interfere with the local oscillation light, and uses a mixing detection technology to measure the frequency difference between a sending beam and a receiving beam, and then calculates the distance of the target by using the frequency difference. In short, a ToF device uses time to measure distance, while a FMCW device uses frequency to measure distance. FMCW has the following advantages over ToF: light waves used in ToF are easily interfered by ambient light, while light waves used in FMCW have strong anti-interference capabilities; a signal-to-noise ratio of the ToF is too low, while a signal-to-noise ratio of the FMCW is very high; a data quality in a speed dimension of the ToF is low, while FMCW can obtain speed dimension data for each pixel.

In the related art, a detection beam emitted by the FMCW LiDAR device is usually TE mode polarization light, which is convenient for transmission in the single-mode waveguide within the chip. When the TE mode polarization light encounters an obstacle, a reflected beam is generated. The reflection beam usually does not have a specific polarization characteristic. For example, it is natural light. It can be considered that the reflection beam includes TE mode polarization light and TM mode polarization light. Usually, only the TM mode polarization light in the reflection beam is received by the receiving end for determining the obstacle. The FMCW LiDAR device in the related art requires a strong enough detection beam to obtain a TM mode polarization light in the reflection beam strong enough to be used effectively, which requires the FMCW LiDAR device with a higher power. When the power of the FMCW LiDAR device is too small, the TM mode polarization light in reflected beam that can be effectively used is weak, which may cause the FMCW LiDAR device has a low detection probability.

The present disclosure provides a LIDAR device, which includes: a LiDAR chip, wherein the LiDAR chip includes at least one laser transmission detection channel, which is configured to transmit a detection beam with a first polarization state and a local oscillation beam with the first polarization state, and the laser transmission detection channel includes: a light transmitting end, which is configured to transmit the detection beam, and the detection beam is reflected after encountering an obstacle to generate a reflected beam. The reflection beam includes a first reflection sub-beam with the first polarization state and a second reflection sub-beam with a second polarization state; a light receiving end, which is configured to receive at least one of the first reflection sub-beam and the second reflection sub-beam; a mixer, which receives the local oscillation beam and the reflection beam, and performs a frequency-mixing operation on the local oscillation beam and the reflection beam to output a mixed beam; and a detector, which is configured to receive the mixed beam and output a detection electrical signal, and the LiDAR device determines the distance and/or the speed of the obstacle according to the detection electrical signal.

The LiDAR device transmits the detection beam with the first polarization state through the transmission detection channel and receives the reflection beam including the first reflection sub-beam with the first polarization state and the second reflection sub-beam with the second polarization state, thereby making full use of the reflection beam to measure the obstacle and improve the detection probability. At the same time, it avoids the situation where the obstacle cannot be detected since the TM mode polarization light is weak and the TE mode polarization light in the reflection beam reflected from the obstacle is strong.

The optional embodiments of the present disclosure are described in detail below with reference to the accompanying drawings.

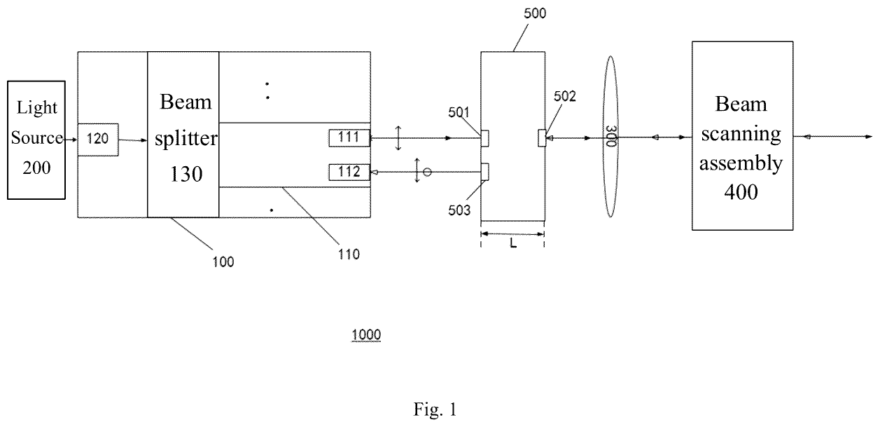

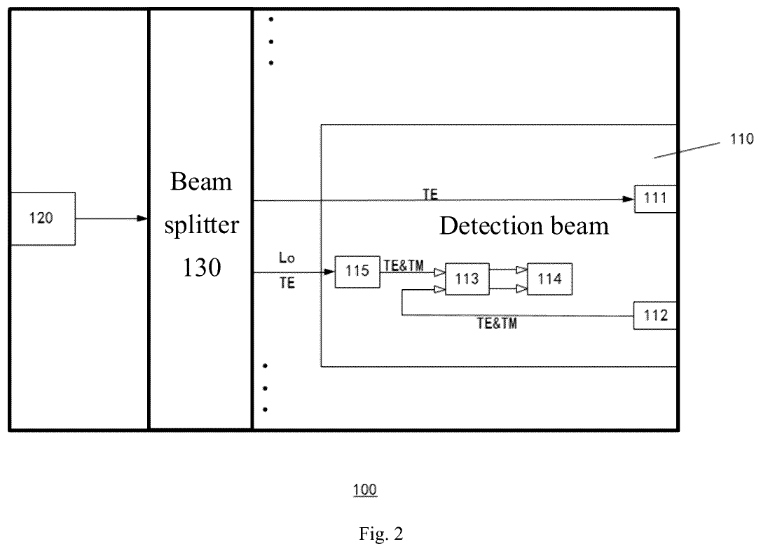

FIG. 1 is a schematic diagram of a structure of a LiDAR device provided in some embodiments of the present disclosure, and FIG. 2 is a schematic diagram of a partial structure of a LiDAR chip provided in some embodiments of the present disclosure. As shown in FIG. 1 and FIG. 2, the present disclosure provides a LiDAR device 1000 including a LiDAR chip 100, which is a FMCW LiDAR chip.

The LiDAR chip 100 includes a substrate and at least one laser transmission detection channel 110 disposed on the substrate, and the substrate is, for example, a silicon-based substrate. The number of laser transmission detection channels 110 is one or more. Each laser transmission detection channel 110 is configured to emit a detection beam; the detection beam encounters the obstacle and is reflected by the obstacle to generate a corresponding reflected beam, and each laser transmission detection channel 110 is also configured to receive the corresponding reflected beam to facilitate the determination at the channel.

The multiple laser transmission detection channels 110 can respectively measure multiple points on the corresponding obstacle, such as measuring the distance, the speed and other parameters of each point, where the distance refers to the distance between the point and the LiDAR device, and the speed refers to the speed of the point relative to the LiDAR device, and then measure the distance, the speed, the shape and other parameters of the entire obstacle.

Each laser transmission detection channel 110 has the same working principle, and a laser transmission detection channel 110 is taken as an example for a specific description below.

The laser transmission detection channel 110 is configured to transmit a detection beam having a first polarization state and a local oscillation beam Lo having the first polarization state. The first polarization state is, for example, a TE polarization mode. The detection beam is, for example, a TE mode polarization light.

The laser transmission detection channel 110 includes a light transmitting end 111, a light receiving end 112, a mixer 113 and a detector 114.

The light transmitting end 111 is configured to emit the detection beam, and the detection beam is reflected after the detection beam encounters the obstacle to generate a reflected beam, and the reflection beam includes a first reflection sub-beam with the first polarization state and a second reflection sub-beam with a second polarization state. The second polarization state is, for example, a TM polarization mode. The detection beam in the TE polarization mode is reflected after being incident on an obstacle, and the generated reflected beam generally includes both TE mode polarization light and TM mode polarization light, and the polarization directions of the TE mode polarization light and the TM mode polarization light are perpendicular to each other.

The light receiving end 112 is configured to receive at least one of the first reflection sub-beam and the second reflection sub-beam. As shown in FIG. 1, the first reflection sub-beam and the second reflection sub-beam are both coupled to the light receiving end 112, that is, the reflection beam including the TE mode polarization light and the TM mode polarization light enters the laser transmission detection channel 110 from the light receiving end 112.

The mixer 113 receives the local oscillation beam Lo and the reflection beam including the TE mode polarization light and the TM mode polarization light, and performs a frequency-mixing operation on the local oscillation beam and the reflection beam to output a mixed beam. The mixer 113 is, for example, a 2×2 coupler.

The detector 114, for example a balanced detector, is configured to receive the frequency-frequency-mixed beam and output a detection electrical signal, and the LiDAR device 1000 determines the distance and/or the speed of the obstacle relative to the LiDAR device based on the detection electrical signal.

In the present disclosure, the LiDAR device receives the reflection beam including a first reflection sub-beam having a first polarization state and a second reflection sub-beam having a second polarization state through a laser transmission detection channel, and makes full use of the reflection beam to measure the obstacle, thereby improving the detection probability. At the same time, it avoids the situation where the obstacle cannot be detected since the TM mode polarization light in the reflection beam is weak and the TE mode polarization light in the reflection beam is strong.

In some embodiments, as shown in FIG. 1 and FIG. 2, the LiDAR device 1000 further includes a lens assembly 300 and a beam scanning assembly 400. The lens assembly 300 may be a lens or a lens group, and has focusing and collimating functions. The lens assembly 300 is configured to collimate and deflect the detection beam emitted by the light transmitting end 111, and to focus the reflection beam to be coupled into the laser transmission detection channel, for example, to be coupled into the light transmitting end 111 or the light receiving end 112.

The beam scanning assembly 400 is disposed on the side, close to the obstacle, of the lens assembly 300, and is configured to adjust the emission direction of the detection beam emitted from the light transmitting end 111 over time to achieve light beam scanning. The beam scanning assembly 400 is, for example, an optical phased array (OPA), which can guide the direction of the light beam by dynamically controlling the optical properties of the surface of the OPA at a microscopic scale. In other embodiments, the beam scanning assembly may also include a grating, a mirror galvanometer, a polygon mirror, a Micro-Electro-Mechanical System (MEMS) mirror, or a combination of an optical phased array (OPA) and the above devices.

In some embodiments, as shown in FIG. 1 and FIG. 2, the LiDAR device 1000 further includes a circulator 500, which is disposed between the LiDAR chip 100 and the lens assembly 300 and is configured for transmitting the detection beam and the reflection beam.

Specifically, the circulator 500 includes a first port 501, a second port 502, and a third port 503. A light beam incident into the circulator from the first port 501 will be output from the second port 502 while maintaining optical properties, and a light beam incident into the circulator from the second port 502 will be output from the third port 503 while maintaining optical properties.

In this embodiment, the first port 501 is configured to receive the detection beam having the first polarization state, such as TE mode polarization light. In the drawings, a solid arrow is used to indicate the transmission direction of the TE mode polarization light, and a double arrow line is used to indicate the polarization direction of the TE mode polarization light.

The second port 502 is configured to transmit the detection beam to the lens assembly and receive the reflection beam, wherein the reflection beam includes a first reflection sub-beam with the first polarization state and a second sub-reflected beam with a second polarization state, which are coaxial, that is, the reflection beam includes TE mode polarization light and TM mode polarization light which are coaxial. In the accompanying drawings, solid arrows are used to indicate the transmission direction of the reflection beam, and blank circles are used to indicate the polarization direction of the TM mode polarization light.

The third port 503 is configured to transmit the reflection beam to the laser transmission detection channel 100, so that the first reflection sub-beam and the second reflection sub-beam are coaxially coupled to enter the light receiving end 112. That is, the reflection beam including the TE mode polarization light and the TM mode polarization light which are coaxial enters the laser transmission detection channel 110 from the light receiving end 112.

In some embodiments, the laser transmission detection channel 100 also includes a polarization rotator 115, which is configured to receive a local oscillation beam Lo having the first polarization state, where the local oscillation beam is, for example, TE mode polarization light. The polarization rotator 115 converts the local oscillation beam into a first local oscillation sub-beam having the first polarization state and a second local oscillation sub-beam having the second polarization state, where the first local oscillation sub-beam is, for example, TE mode polarization light, and the second local oscillation sub-beam is, for example, TM mode polarization light, and the first local oscillation sub-beam and the second local oscillation sub-beam are transmitted coaxially.

The mixer 113 is configured to receive the first local oscillation sub-beam and the first reflection sub-beam, and perform a frequency-mixing operation on the first local oscillation sub-beam and the first reflection sub-beam to output a first frequency-mixing sub-beam; the mixer 113 is also configured to receive the second local oscillation sub-beam and the second reflection sub-beam, and perform a frequency-mixing operation on the second local oscillation sub-beam and the second reflection sub-beam to output a second frequency-mixing sub-beam. In this embodiment, a single mixer is used to complete the frequency-mixing operation of the first local oscillation sub-beam and the first reflection sub-beam which are TE mode polarization light, and the frequency-mixing operation of the second local oscillation sub-beam and the second reflection sub-beam which are TM mode polarization light.

The detector 114 is configured to receive the first frequency-mixing sub-beam and output a first detection electrical sub-signal, and to receive the second frequency-mixing sub-beam and output a second detection electrical sub-signal. The LiDAR device 1000 determines the distance and/or the speed of the obstacle based on the first detection electrical sub-signal and the second detection electrical sub-signal.

In this embodiment, the LiDAR device makes full use of the TE mode polarization light and the TM mode polarization light in the reflection beam to measure obstacles, thereby improving the detection probability, and completes the measurement using a single mixer 113 and a single detector 114. A simple structure is used to achieve dual polarization detection of TE mode polarization light and TM mode polarization light, thereby ensuring measurement accuracy while reducing manufacturing costs.

In some embodiments, in combination with FIG. 1 and FIG. 2, in some embodiments, as shown in FIG. 1, the LiDAR chip 100 further includes a receiving port 120 and a beam splitter 130. The receiving port 120 is configured to receive laser light, and the laser light is input into the LiDAR chip 100 from the outside, for example. The beam splitter 130 is configured to split the laser light into a detection beam and a local oscillation beam, and the detection beam and the local oscillation beam are configured to be transmitted to the laser transmission detection channel 110. The detection beam and the local oscillation beam have the same frequency, that is, frequency modulation waveforms of the detection beam and the local oscillation beam are exactly the same.

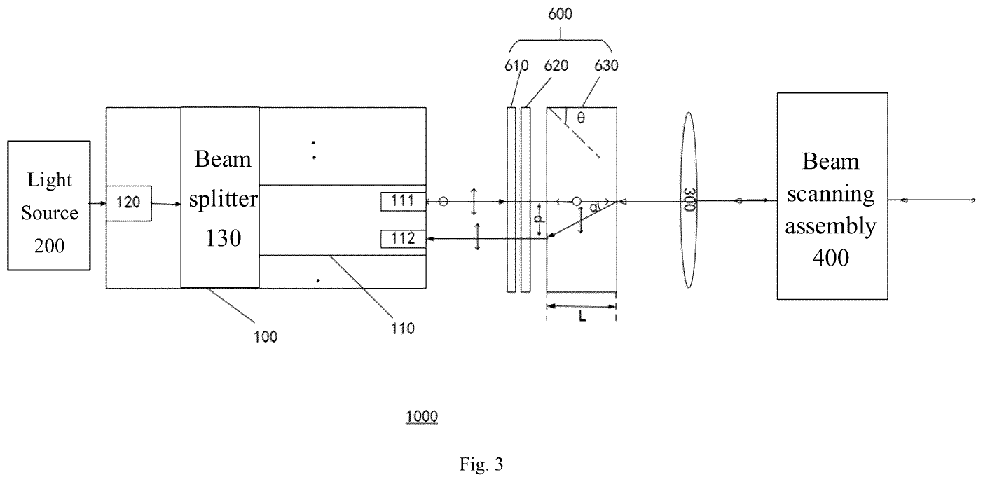

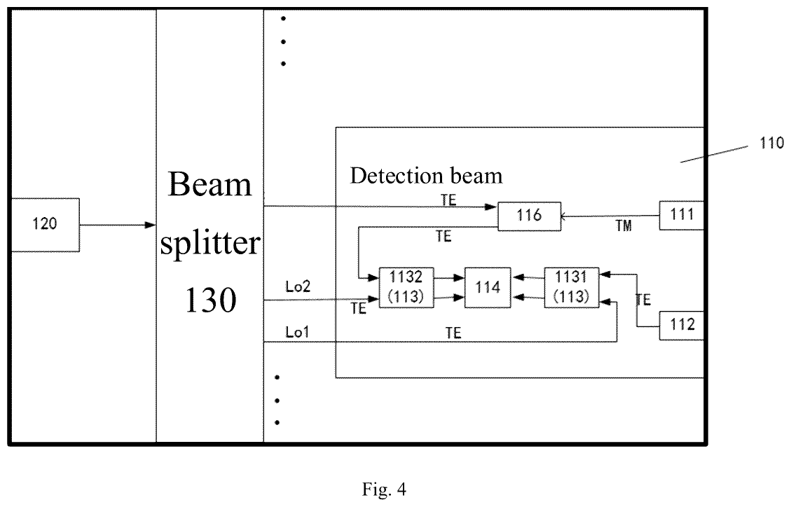

FIG. 3 is a schematic diagram of the structure of a LiDAR device provided in some embodiments of the present disclosure, and FIG. 4 is a schematic diagram of a partial structure of a LiDAR chip provided in some embodiments of the present disclosure. The structures of the embodiments shown in FIGS. 3 and 4 are basically the same as those of the embodiments shown in FIGS. 1 and 2, and the similarities between the two embodiments are not repeated here. The following mainly introduces the differences between the two embodiments.

As shown in FIG. 3 and FIG. 4, the LiDAR device 1000 does not include a circulator 500, the circulator in FIG. 1 and FIG. 2 is replaced by a polarization transmission beam splitter 600. The polarization transmission beam splitter 600 is arranged between the LiDAR chip 100 and the lens assembly 300. The polarization transmission beam splitter is configured to: allow the detection beam to pass through in the original direction; deflect and translate the first reflection sub-beam in the reflection beam so that the first reflection sub-beam is incident on the light receiving end 112; and allow the second reflection sub-beam in the reflection beam to pass through in the original direction so that the second reflection sub-beam is incident on the light transmitting end 111, and the light transmitting end coaxially transmits the detection beam and receives the second reflection sub-beam. The polarization transmission beam splitter 600 separates the first reflection sub-beam and the second reflection sub-beam originally coaxially transmitted, and transmits them to the light receiving end 112 and the light transmitting end 111 respectively. The first reflection sub-beam is, for example, TE mode polarization light, and the second reflection sub-beam is, for example, TM mode polarization light.

In some embodiments, as shown in FIG. 3 and FIG. 4, the local oscillation beam Lo includes a first local oscillation beam Lo1 and a second local oscillation beam Lo2, and the first local oscillation beam Lo1 and the second local oscillation beam Lo2 are the same.

The mixer 113 includes a first mixer 1131 and a second mixer 1132, which are respectively arranged on both sides of the detector 114. Each of the first mixer 1131 and the second mixer 1132 is, for example, a 2×2 coupler. The first mixer 1131 is configured to receive the first local oscillation beam Lo1 and the first reflection sub-beam, and perform a frequency-mixing operation on the first local oscillation beam and the first reflection sub-beam to output a first frequency-mixed beam; the second mixer 1132 is configured to receive the second local oscillation beam and the second reflection sub-beam, and perform a frequency-mixing operation on the second local oscillation beam and the second reflection sub-beam to output a second frequency-mixed beam. In this embodiment, two mixers are used to respectively complete the frequency-mixing operation of the first local oscillation beam and the first reflection sub-beam, and the frequency-mixing operation of the second local oscillation beam and the second reflection sub-beam.

The detector 114 is configured to receive the first frequency-mixed beam and output a first detection electrical signal, and to receive the second frequency-mixed beam and output a second detection electrical signal. The LiDAR device 1000 determines the distance and/or the speed of the obstacle based on the first detection electrical signal and the second detection electrical signal.

In this embodiment, the LiDAR device makes full use of the TE mode polarization light and the TM mode polarization light in the reflection beam to measure obstacles, thereby improving the detection probability, and completes the measurement using a single detector 114, thereby ensuring measurement accuracy while reducing manufacturing costs.

In some embodiments, as shown in FIG. 4, the laser transmission detection channel 110 further includes: a polarization splitter and rotator 116 configured to receive the second reflection sub-beam, change the polarization state of the second reflection sub-beam from the second polarization state to the first polarization state, and transmit the second reflection sub-beam to the second mixer 1132 after the polarization state is changed. Specifically, the polarization splitter and rotator 116 allows the detection beam which is TE mode polarization light to maintain the original direction, and the detection beam is transmitted to the light transmitting end 111 through the polarization splitter and rotator 116 for emission. The polarization splitter and rotator 116 changes the polarization state of the second reflection sub-beam which is TM mode polarization light, and the second reflection sub-beam is converted from TM mode polarization light to TE mode polarization light after passing through the polarization splitter and rotator 116. The first local oscillation beam Lo1 and the second local oscillation beam Lo2 are also both TE mode polarization light. The first local oscillation beam Lo1 and the first reflection sub-beam, which are both TE mode polarization light, are output to the first mixer 1131 to perform a frequency-mixing operation and output the first frequency-mixed beam. The second local oscillation beam Lo1 and the second reflection sub-beam, both of which are TE mode polarization light, are output to the second mixer 1132 to perform frequency-mixing operation to output a second frequency-mixed beam.

In some embodiments, the polarization transmission beam splitter 600 includes a Faraday rotator 610, a half-wave plate 620, and a polarization beam deflector 630, which are arranged sequentially away from the LiDAR chip 100.

The detection beam is converted from polarized light in the first polarization state to polarized light in the second polarization state after passing through the Faraday rotator 610 and the half-wave plate 620 in sequence. The polarized light in the second polarization state passes through the polarization beam deflector 630 with the original direction unchanged, and then passes through the lens assembly 300 and the beam scanning assembly 400 in sequence before reaching the obstacle to generate the reflection beam. The reflection beam returns to the polarization beam deflector 630 along the original optical path. The second reflection sub-beam with the second polarization state in the reflection beam passes through polarization beam deflector 630 with the original direction unchanged, and then passes through the half-wave plate 620 and the Faraday rotator 610 in sequence, and then enters the light transmitting end 111. The first reflection sub-beam with the first polarization state in the reflection beam passes through the polarization beam deflector 630 and is deflected and translated, and then passes through the half-wave plate 620 and the Faraday rotator 610 in sequence, and then enters the light receiving end 112.

As shown in FIG. 3 and FIG. 4, the detection beam transmitted from the light transmitting end 111 is TE mode polarization light. After the detection beam passes through the Faraday rotator 610 and the half-wave plate 620 in sequence, the TE mode polarization light is converted into TM mode polarization light. Specifically, the Faraday rotator 610 performs a 45-degree deflection on the polarization direction of the detection beam, and the half-wave plate 620 also performs a 45-degree deflection on the polarization direction of the detection beam. The detection beam which is the TM mode polarization light passes through the polarization beam deflector 630 with the direction unchanged, and then passes through the lens assembly 300 and the beam scanning assembly in sequence before reaching the obstacle to generate the reflection beam. After the detection beam passes through the polarization beam deflector 630 with the original direction unchanged, the detection beam is still transmitted in a direction parallel to the optical axis of the lens assembly 300. The lens assembly 300 performs collimation on the detection beam. The detection beam has a certain divergence angle. After passing through the lens assembly 300, the detection beam is collimated into a parallel beam and deflected toward the optical axis of the lens assembly 300. The beam scanning assembly 400 adjusts the emission direction of the detection beam over time to achieve beam scanning.

The detection beam which is the TM mode polarization light encounters an obstacle, a corresponding reflected beam is generated. The reflection beam does not have a specific polarization characteristic, and may be such as natural light. It can be considered that the reflection beam includes both TE mode polarization light and TM mode polarization light. The reflection beam returns to the polarization beam deflector 630 along the original optical path. The TM mode polarization light in the reflection beam passes through the polarization beam deflector 630 with the original direction unchanged, and then passes through the half-wave plate 620 and the Faraday rotator 610 in sequence, and then enters the light transmitting end 111. Specifically, the half-wave plate 620 performs a 45-degree deflection on the polarization direction of the TM mode polarization light in the reflection beam, and the Faraday rotator 610 performs a −45-degree deflection on the polarization direction of the TM mode polarization light in the reflection beam. After passing through the polarization beam deflector 630, the TE mode polarization light in the reflection beam passes through the half-wave plate 620 and the Faraday rotator 610 in sequence with the polarization state and the transmission direction unchanged. The TE mode polarization light in the reflection beam is deflected and translated by the polarization beam deflector 630, and then passes through the half-wave plate 620 and the Faraday rotator 610 in sequence, and then enters the light receiving end 112. After passing through the polarization beam deflector 630, the TM mode polarization light in the reflection beam passes through the half-wave plate 620 and the Faraday rotator 610 in sequence with the polarization state and the transmission direction unchanged. Specifically, the half-wave plate 620 performs a 45-degree deflection on the polarization direction of the TE mode polarization light in the reflection beam, and the Faraday rotator 610 performs a −45-degree deflection on the polarization direction of the TE mode polarization light in the reflection beam.

In some embodiments, the distance between the light transmitting end 111 and the light receiving end 112 is substantially equal to an offset distance d of the polarization beam deflector 630 to the TE mode polarization light in the reflection beam, and the offset distance d satisfies the following formula:

$$tan ( α ) = ( 1 - \frac{{n}_{o}^{2}}{{n}_{e}^{2}} ) \cdot \frac{tan ( θ )}{1 + \frac{{n}_{o}^{2}}{{n}_{e}^{2}} \cdot {tan}^{2} ( θ )}$$

$$d = L \cdot tan ( α )$$

wherein, L is the thickness of the polarization beam deflector, α is the deflection angle of the polarization beam deflector to the TE mode polarization light, θ is the angle between the optical axis of the polarization beam deflector and the wave vector, nₒ is the refractive index of the TM mode polarization light in the polarization beam deflector, and nₑ is the refractive index of the TE mode polarization light in the polarization beam deflector. As shown in FIG. 3, the wave vector is, for example, in the horizontal direction, and the optical axis of the polarization beam deflector is indicated by a broken line.

In some embodiments, in combination with FIG. 3 and FIG. 4, as shown in FIG. 1, the LiDAR chip 100 further includes a receiving port 120 and a beam splitter 130. The receiving port 120 is configured to receive laser light, and the laser light is input into the LiDAR chip 100 from the outside, for example. The beam splitter 130 is configured to split the laser light into a detection beam, a first local oscillation beam Lo1, and a second local oscillation beam Lo2. The detection beam, the first local oscillation beam Lo1, and the second local oscillation beam Lo2 are configured to be transmitted to the laser transmission detection channel 110. The detection beam, the first local oscillation beam Lo1, and the second local oscillation beam Lo2 all have the same frequency, that is, the frequency modulation waveforms of the detection beam and the local oscillation beam are exactly the same.

In some embodiments, as shown in FIG. 1 or FIG. 4, the LiDAR device 1000 further includes a laser light source 200, which is connected to the LiDAR chip 100 and configured to generate laser light. At least a portion of the laser light is used as the detection beam to perform detection.

The laser light emitted by the laser light source 200 is, for example, linear frequency-sweep laser light, and the laser light source 200 is, for example, a solid-state laser device, a semiconductor laser device, etc., and specifically can be a distributed feedback laser (DFB) device, a vertical cavity surface emitting laser (VCSEL) device, an external cavity laser device, etc. The laser light source 200 is, for example, an external light source, which is introduced into the LiDAR chip 100 through an optical path (such as an optical fiber).

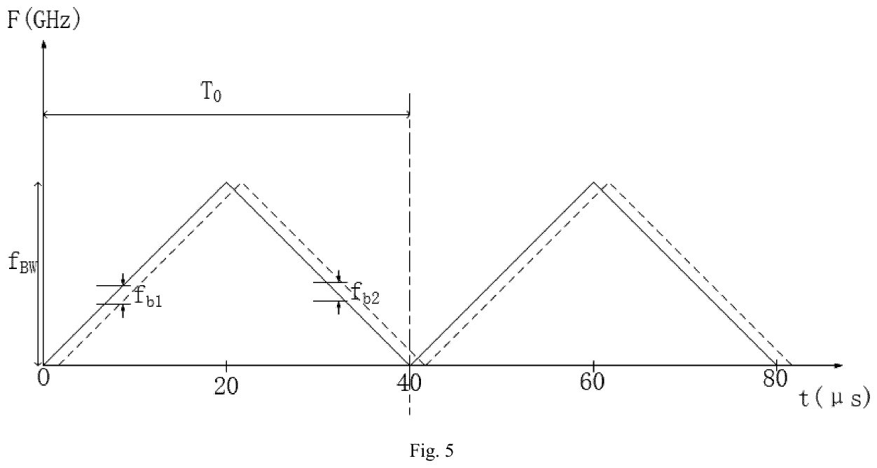

FIG. 5 is a waveform diagram of the emitted light beam and the received light beam of the FWCW frequency-sweeping method provided by the present disclosure. As shown in FIG. 5, the frequency-sweeping light signal of the emitted light beam emitted by the multi-channel LiDAR device is represented by a solid line, which reflects the curve of the frequency of the emitted light beam changing with time. The frequency-sweeping light signal is, for example, a periodic triangular-wave signal. The reflected light signal of the reflection beam received by the LiDAR device is represented by a dotted line, which reflects the curve of the frequency of the received reflected light beam changing with time. The reflected light signal is also, for example, a periodic triangular-wave signal, and there is a delay between the reflected light signal and the frequency-sweeping light signal.

FIG. 5 shows only two frequency sweep measurement cycles. In each frequency sweep measurement cycle, the frequency-sweeping light signal includes a frequency-increasing phase and a frequency-decreasing phase. Accordingly, the corresponding reflected light signal also includes a frequency-increasing phase and a frequency-decreasing phase.

As shown in FIG. 5, the horizontal axis represents time, the unit thereof is μs, and the vertical axis represents frequency, the unit thereof is GHz. The frequency of the emitted light beam, for example, increases from 0 to 4 GHz with the increase of time, and then decreases from 4 GHz to 0, and changes periodically in this way. Correspondingly, the frequency of the received reflected light beam also increases from 0 to 4 GHz with the increase of time, and then decreases from 4 GHz to 0, and changes periodically in this way.

For any measurement point, the distance R of the obstacle is determined by the following formula:

$$R = \frac{{C}_{0}}{8} \frac{{T}_{0}}{{f}_{BW}} ( {f}_{b 1} - {f}_{b 2} )$$

wherein, T₀ is a preset frequency sweep measurement period, f_{BW} is a preset frequency sweep bandwidth, f_{b1} is a beat frequency in a frequency-increasing stage, f_{b2} is a beat frequency in a frequency-decreasing stage, and C₀ is the speed of light.

The speed v of the obstacle satisfies the following relationship:

$$v = - \frac{{C}_{0}}{4} \frac{1}{{f}_{0}} ( {f}_{b 1} - {f}_{b 2} )$$

wherein C₀ is the speed of light, f_{b1} is the beat frequency in the frequency-increasing stage, fb2 is the beat frequency in the frequency-decreasing stage, and f₀ is the frequency of the unmodulated light beam.

The various parts of the present disclosure are described in a combination of parallel and progressive manners. Each part focuses on the differences from other parts, and the same or similar parts between the various parts can be referenced to each other.

With respect to the above description of the disclosed embodiments, the features described in the embodiments in this specification may be replaced or combined with each other, so that a person skilled in the art can implement or use the present application. Various modifications to these embodiments will be apparent to the person skilled in the art, and the general principles defined herein may be implemented in other embodiments without departing from the spirit or scope of the present application. Therefore, the present application will not be limited to the embodiments shown herein, but will conform to the widest scope consistent with the principles and novel features disclosed herein.

Finally, it should be noted that: each embodiment in this specification is described by way of example, and each embodiment focuses on the differences from other embodiments, and the same or similar parts between the embodiments can be referred to each other. For the system or device disclosed in the embodiment, since the system or the device corresponds to the method disclosed in the embodiment, the description is relatively simple, and the relevant parts can be referred to the method part.

The above embodiments are only used to illustrate the technical solutions of the present disclosure, rather than to limit them. Although the present disclosure has been described in detail with reference to the aforementioned embodiments, those skilled in the art should understand that they can still modify the technical solutions described in the aforementioned embodiments, or make equivalent replacements for some of the technical features therein. However, these modifications or replacements do not deviate the essence of the corresponding technical solutions from the spirit and scope of the technical solutions of the embodiments of the present disclosure.

What is claimed is:

1. A Light Detection And Ranging (LiDAR) device, comprising:
a LiDAR chip, comprising at least one laser transmission detection channel configured to transmit a detection beam having a first polarization state and a local oscillation beam having the first polarization state, wherein each of the at least one laser transmission detection channel comprises:
a light transmitting end configured to emit the detection beam, wherein a reflection beam is generated after the detection beam encounters the obstacle and is reflected by the obstacle, the reflection beam comprises a first reflection sub-beam having a first polarization state and a second reflection sub-beam having a second polarization state;
a light receiving end configured to receive at least one of the first reflection sub-beam and the second reflection sub-beam;
one or more mixers configured to receive the local oscillation beam and the reflection beam, and perform a frequency-mixing operation on the local oscillation beam and the reflection beam to output a frequency-mixed beam; and
a detector configured to receive the frequency-mixed beam and output a detection electrical signal, wherein a distance and/or a speed of the obstacle is determined based on the detection electrical signal.

2. The LiDAR device according to claim 1, further comprising:
a lens assembly configured to collimate and deflect the detection beam emitted from the light transmitting end, and to focus the reflection beam to enable the reflection beam to be coupled into the laser transmission detection channel; and
a beam scanning assembly on a side, close to the obstacle, of the lens assembly and configured to adjust an emission direction of the detection beam emitted from the light transmitting end over time to achieve beam scanning.

3. The LiDAR device according to claim 2, further comprising a circulator between the LiDAR chip and the lens assembly, wherein the circulator comprises:
a first port configured to receive the detection beam;
a second port configured to emit the detection beam toward the lens assembly and receive the reflection beam; and
a third port configured to transmit the reflection beam to the laser transmission detection channel, so that the first reflection sub-beam and the second reflection sub-beam are coaxially coupled into the light receiving end.

4. The LiDAR device according to claim 3, wherein the laser transmission detection channel further comprises:
a polarization rotator configured to receive the local oscillation beam and convert the local oscillation beam into a first local oscillation sub-beam having the first polarization state and a second local oscillation sub-beam having the second polarization state,
wherein the one or more mixers are configured to receive the first local oscillation sub-beam and the first reflection sub-beam, and perform a frequency-mixing operation on the first local oscillation sub-beam and the first reflection sub-beam to output a first frequency-mixing sub-beam; and the one or more mixers are configured to receive the second local oscillation sub-beam and the second reflection sub-beam, and perform a frequency-mixing operation on the second local oscillation sub-beam and the second reflection sub-beam to output a second frequency-mixing sub-beam;
the detector is configured to receive the first frequency-mixing sub-beam and output a first detection electrical sub-signal, and to receive the second frequency-mixing sub-beam and output a second detection electrical sub-signal,
the distance and/or the speed of the obstacle are determined based on the first detection electrical sub-signal and the second detection electrical sub-signal by the LiDAR device.

5. The LiDAR device according to claim 3, wherein the LiDAR chip further comprises:
a receiving port configured to receive laser light; and
a beam splitter configured to split the laser light into the detection beam and the local oscillation beam, wherein the detection beam and the local oscillation beam are configured to be transmitted to the laser transmission detection channel.

6. The LiDAR device according to claim 2, further comprising a polarization transmission beam splitter between the LiDAR chip and the lens assembly, and the polarization transmission beam splitter is configured to:
allow the detection beam to pass through with an original direction of the detection beam unchanged;
deflect and translate a first reflection sub-beam in the reflection beam so that the first reflection sub-beam is incident on the light receiving end; and
allow a second reflection sub-beam in the reflection beam to pass through with an original direction of the second reflection sub-beam unchanged, so that the second reflection sub-beam is incident on the light transmitting end, and the light transmitting end coaxially transmits the detection beam and receives the second reflection sub-beam.

7. The LiDAR device according to claim 6, wherein the local oscillation beam comprises a first local oscillation beam and a second local oscillation beam,
the one or more mixers comprise a first mixer and a second mixer respectively arranged on both sides of the detector, wherein the first mixer is configured to receive the first local oscillation beam and the first reflection sub-beam, and perform a frequency-mixing operation on the first local oscillation beam and the first reflection sub-beam to output a first frequency-mixed beam; the second mixer is configured to receive the second local oscillation beam and the second reflection sub-beam, and perform a frequency-mixing operation on the second local oscillation beam and the second reflection sub-beam to output a second frequency-mixed beam;
the detector is configured to receive the first frequency-mixed beam and output a first detection electrical signal, and to receive the second frequency-mixed beam and output a second detection electrical signal,
wherein the LiDAR device determines the distance and/or the speed of the obstacle based on the first detection electrical signal and the second detection electrical signal.

8. The LiDAR device according to claim 7, wherein the laser transmission detection channel comprises:
a polarization splitter and rotator configured to receive the second reflection sub-beam, change a polarization state of the second reflection sub-beam from the second polarization state to the first polarization state, and transmit the second reflection sub-beam with the changed polarization state to the second mixer.

9. The LiDAR device according to claim 6, wherein the polarization transmission beam splitter comprises a Faraday rotator, a half-wave plate and a polarization beam deflector sequentially away from the LiDAR chip;
the detection beam is converted from polarized light in the first polarization state to polarized light in the second polarization state after passing through the Faraday rotator and the half-wave plate in sequence; the polarized light in the second polarization state passes through the polarization beam deflector with an original direction of the polarized light unchanged, and then passes through the lens assembly and the beam scanning assembly in sequence before reaching the obstacle to generate the reflection beam;
the reflection beam returns to the polarization beam deflector along an original optical path of transmitting the detection beam; the second reflection sub-beam with the second polarization state in the reflection beam passes through polarization beam deflector with an original direction of the second reflection sub-beam unchanged, and then passes through the half-wave plate and the Faraday rotator in sequence, and then enters the light transmitting end;
the first reflection sub-beam with the first polarization state in the reflection beam passes through the polarization beam deflector and is deflected and translated, and then passes through the half-wave plate and the Faraday rotator in sequence, and then enters the light receiving end.

10. The LiDAR device according to claim 6, wherein the LiDAR chip further comprises:
a receiving port configured to receive laser light; and
a beam splitter configured to split the laser light into the detection beam, the first local oscillation beam and the second local oscillation beam; the detection beam, the first local oscillation beam and the second local oscillation beam are configured to be transmitted to the laser transmission detection channel.

11. The LiDAR device according to claim 4, wherein the LiDAR chip further comprises:
a receiving port configured to receive laser light; and
a beam splitter configured to split the laser light into the detection beam and the local oscillation beam, wherein the detection beam and the local oscillation beam are configured to be transmitted to the laser transmission detection channel.

12. The LiDAR device according to claim 7, wherein the LiDAR chip further comprises:
a receiving port configured to receive laser light; and
a beam splitter configured to split the laser light into the detection beam, the first local oscillation beam and the second local oscillation beam; the detection beam, the first local oscillation beam and the second local oscillation beam are configured to be transmitted to the laser transmission detection channel.

13. The LiDAR device according to claim 8, wherein the LiDAR chip further comprises:
a receiving port configured to receive laser light; and
a beam splitter configured to split the laser light into the detection beam, the first local oscillation beam and the second local oscillation beam; the detection beam, the first local oscillation beam and the second local oscillation beam are configured to be transmitted to the laser transmission detection channel.

14. The LiDAR device according to claim 9, wherein the LiDAR chip further comprises:
a receiving port configured to receive laser light; and
a beam splitter configured to split the laser light into the detection beam, the first local oscillation beam and the second local oscillation beam; the detection beam, the first local oscillation beam and the second local oscillation beam are configured to be transmitted to the laser transmission detection channel.
